(19) United States
(12) Patent Application Publication
(10) Pub. No.: US 2005/0229349 A1
(43) Pub. Date: Oct. 20, 2005

(54) Cleaning mitt, use of said glove as an animal grooming glove and an animal grooming kit

(76) Inventor: Manfred Foser, Balzers (LI)

Correspondence Address: NIXON & VANDERHYE, PC, 901 NORTH GLEBE ROAD, 11TH FLOOR, ARLINGTON, VA, 22203, US

(21) Appl. No.: 10/497,182

(22) PCT Filed: Dec. 2, 2002
(86) PCT No.: PCT/CH02/00652

§ 371 Date: Jun. 6, 2005

(30) Foreign Application Priority Data
Nov. 30, 2001 (CH) 2194/01

(51) Int. Cl. A47L 13/18

(52) U.S. Cl. 15/227; 15/104.94; 119/602; 119/603

(57) ABSTRACT

The invention relates to a mitt and to a grooming kit for the coat of an animal. The mitt comprises at least one cleaning surface consisting of microfibres and a second cleaning surface with a brush-type covering. The microfibre side can absorb relatively large amounts of moisture by capillary action, said moisture being in turn easily transferred to the coat of an animal that is to be groomed, if the coat is treated using the microfibre side. The brush-type covering, consisting of individual bundles of bristles, is used to transfer the moisture to the interior of the coat and to simultaneously remove foreign bodies from said coat. The interior of the mitt is provided with a loop, into which individual fingers or optionally the whole hand can be inserted. The loop permits a good grip and ensures that the hand cannot slip inside the mitt.

The invention relates to a glove in accordance with the preamble of claim 1, the use of the glove as an animal grooming glove and an animal grooming kit in accordance with claims 26 or 27.

Various grooming means for domestic animals are available in commerce. They comprise, in particular, a multiplicity of different washing means, as well as brushes and combs for grooming the coat of an animal. Brushes have the advantage that they can be readily held in the hand. They are primarily suitable for removing loose hair from the coat. U.S. Pat. No. 3,749,064 relates to an apparatus for bathing dogs and, more precisely, for washing, drying and spraying or de-fleaing dogs. The apparatus consists of a housing with a glove attached to each side thereof. The gloves can be equipped with brushes, ribs, bristles or a sponge. The various working surfaces can be clipped or pulled onto the hand part of the glove. According to a particular embodiment, a sponge is provided on one side of the glove and a comb or a brush on the other side thereof.

U.S. Pat. No. 4,902,283 relates to a mitten for cleaning babies. The mitten consists of several layers that are joined together on three sides to form a bag-like glove or mitt. The layers facing each other on the interior of the mitt consist of water-repellent plastic layers that are surrounded on the outside by absorbing layers made of cotton or similar. Following use, the mitten is everted, its open end is closed and the mitt is thrown away into a garbage can. With a view to facilitating eversion, a ring is provided on the inside in the area of the finger tips in which the middle finger may be inserted when the user pulls the ring, the glove will be everted inwards. During use the ring may also serve to fix the glove to the hand.

U.S. Pat. No. 4,670,930 discloses a cleaning glove in the form of a pocket to accommodate the hand of the user. The cleaning glove serves particularly for cleaning cars. The external sides of the glove are provided with different cleaning surfaces. The front side of the glove has a hairy surface for cleaning such smooth surfaces as glass, metal or plastic. The rear side of the glove, on the other hand, is provided with bristles. In order to avoid the cleaning glove slipping from the hand of the user, the opening is made smaller than the rest of the glove body.

EP-A-0 512 695 discloses a porous, three-dimensional sheet material for brushing animals. The sheet material can be fixed to the hand by means of a strap. According to a first embodiment, two layers of the material are joined together to form a mitten by welding the edges. In the area of the wrist the mitten is made narrower, so that it cannot readily slip from the hand when it is used.

According to another embodiment, the sheet material is provided with a strap on its back side in order to fix it to the user's hand.

Quite generally, there exists a need for an efficient cleaning means that is easy to use and with which both fine and coarser and strongly attached dirt can be removed from smooth or structured surfaces.

It is the object of the present invention to make available a glove that is particularly suitable for the cleaning of smooth or structured surfaces, especially lacquer or plastic surfaces of motor vehicles. Another object is to make available a glove that is well adapted to the hand and can be held by persons of every age or height. Yet another object is to make available a grooming means for animal coats with which not only hair, but also foreign matter can be removed from the coat. A further object is to suggest means with which grooming materials and/or nutrients can be applied to the animal coat.

According to the invention, this object is attained by providing the cleaning glove with two different cleaning surfaces, namely a first cleaning surface covered with microfibres and a second cleaning surface that is different from the first and has a brush-type trimming. A brush-type trimming has the advantage that it can be used to remove even obstinate patches, fly or insect droppings for example, or other strongly attached dirt from smooth or structured surfaces. The brush-type trimming may be formed from both natural and plastic bristles. Although a wide range of plastic materials may be used in general principle, polyester, polyamine and polycarbonate plastics are preferred in this connection.

According to a particularly preferred embodiment, use is made not of individual bristles, but rather of bristle tufts, each of which consists of a multiplicity of thin individual bristles. The cross section of the individual bristles may be either round or flat. Preferably, the bristle tufts will be made of band yarn or multifil fibres. This is a simple and economic way of producing them, because a band yarn or a multifil yarn will fan out or split up into a multiplicity of separate small bristles or can be so split up with the help of mechanical means. In connection with the present invention the term band yarn is to be understood as referring to a yarn spun from one or more small bands, where the small band or bands may also be fibrillated. Fibrillated small bands have the advantage of having an improved mechanical cleaning effect. The bristle tufts will advantageously have a length between 2 and 8 mm, preferably a length between 2 and 6 mm, and even more preferably a length between about 3 and 5 mm.

The bristles will advantageously be combined into a bristle cluster and anchored at discreet points to the base tissue of the second cleaning surface. A high density of individual small bristles is realized when the bristles are provided in tufts. The bristle tufts are preferably arranged so as to be equidistant from each other. The brush-type trimming can be produced by introducing the bristles or bristle tufts as pile threads into the base material. This can be done by means of tufting or other production methods well known to persons skilled in the art. Preferably, there will first be produced a double cloth that is joined by means of the pile threads. The pile threads are then cut, so that both of the fabric surfaces will be provided with a brush-type trimming. The bristles or bristle tufts are preferably arranged at regular distances from each other. The distances between individual bristle tufts may amount to between 0.1 and 4 mm, preferably between 1 and 3 mm. Specially preferred is an arrangement in which the mean distance separating the bristle tufts from each other amounts, on average, to between 1.5 millimetres and about 2.5 millimetres. Preferably, the bristle tufts consisting of a multiplicity of individual bristles are arranged in rows and anchored to the base fabric at discreet points, the bristle tufts of adjacent rows being preferably arranged in such a manner as to be displaced with respect to each other. The distance separating the rows from each other preferably amounts to between 1 mm and 2 mm and even more preferably amounts to about 1.5 mm. The bristles may be made of polyester, polyamide, polyolefin, polyacrylnitril or other polymers.

Advantageously, the first cleaning surface will be provided with a pile of microfibres. The microfibres of the pile will advantageously have a fineness count of up to no more than 5 dtex, preferably up to no more than 2 dtex, and even more preferably up to no more than 1 dtex.

The microfibres will preferably be made of a non-absorptive material, for example polyester, polyamide, polyolefin, polyacrylnitril or other polymeric plastics. Due to capillary effects, threads made of such thin microfibres can absorb a relatively large quantity of moisture—even though the microfibres themselves are non-absorptive—and then yield it again with corresponding ease. Furthermore, microfibres have a mechanical cleaning effect. The microfibres are preferably combined into threads that are anchored in the cleaning surface as pile threads. Persons skilled in the art are familiar with various production techniques for introducing pile threads into a base material (knitted or woven fabric). Two woven base fabrics are preferably produced, which at first are joined to each other by means of pile threads. When the pile threads are cut in the middle, one obtains two woven fabrics with upstanding pile threads. The threads made of a multiplicity of microfibres may also have the form of loops or slings (looping pile).

Further advantageous embodiments of the glove in accordance with the invention are defined by the dependent claims.

According to a second and independent aspect of the present invention, the glove is made in the form of a bag with an opening for the introduction of a hand and on at least one of the interior sides of the glove there is arranged a loop into which the user may put a hand or individual fingers. Depending on the width of the hand, between two and four fingers may be inserted in the loop. When the finger are inserted in the loop, all relative movement of hand and glove is effectively prevented.

Preferably, the glove will consist of two layers with different cleaning surfaces that are joined to each on three sides of the circumference. The two layers are advantageously joined by means of sewing. Advantageously, the width of the loop will be less than the width of the layers provided with the cleaning surfaces. This has the advantage that between the loop and the layer on which the cleaning surface is formed there remains a strip of material that can be turned when cleaning corners or used to clean slots.

Advantageously, the loop will be arranged in the forward half of the glove and at some distance from the tip of the glove. This means that when the hand is introduced into it, the loop will embrace the fingers in the region between the metacarpal joints and the inter-phalangeal joints.

Advantageously, the loops will be made from a textile or a plastic strap. Although in general principle a non-yielding or inelastic strap can be used as loop, the loop will preferably be constituted by a yielding or elastic strap. An elastic strap has the advantage that it can adapt to any width of hand and provides an optimal grip. If both sides of the grooming glove are to be used with good effect, it is preferable for both the interior sides of the glove to be provided with at least one loop. When the user changes from one cleaning surface to the other, his hand can be inserted in the loop on the opposite interior side.

Further advantageous embodiments of the glove in accordance with the second aspect of the invention are defined by the dependent claims.

The present invention further also concerns a brush-type trimming obtainable by means of the production of two textile sheet structures or woven fabrics that are joined to each other by means of pile threads consisting of band yarn or multifil yarn, the consolidation of the pile yarns in the base fabric, by impregnation, gluing or welding for example, and cutting of the pile threads, preferably in the middle, thus forming two base fabrics with a brush-type trimming. When bristle tufts are to be formed, the individual multifil yarn or band yarn bristles can be further treated and split with the help of mechanical means, thus forming bristle tufts.

The present invention still further concerns also the use of the glove described above as a glove for grooming animals. Although a wide range of accessories is already being used in the animal grooming sector, nobody has hitherto thought of grooming and/or cleaning animal coats with microfibre surfaces. To the great surprise of the inventor, it was found that, in the case of dogs for example, regular grooming of the coat with microfibres and/or a microfibre cleaning surfaces made it possible to substantially suppress the formation of unpleasant smells. This may well be due to the fact that the substances secreted by the animal, which subsequently adhere to the hair and tend to form odours, can be at least partly removed by means of the microfibres. A particularly advantageous animal grooming glove is obtained when a second cleaning surface with bristles is provided. The to be thoroughly combed and to remove dandruff and to remove both solid and dissolved foreign bodies (material). Furthermore, the brush-type trimming also polishes the coat.

An efficient instrument for grooming animal coats is made available by providing a first cleaning surface of the glove with microfibres and a second cleaning surface with bristle tufts. The microfibres, which are preferably made from a non-absorbing plastic material, become particularly suitable for moistening the coat of the animal when a sufficiently thin microfibres are used. This means that especially the fineness of the employed microfibres is of importance. When use is made of specially thin microfibres, preferably having a fineness count of less than 5 dtex and even more preferably less than 1 dtex, a relatively large amount of water can be drawn in and retained by means of capillary effects. The water that is retained in and/or between the microfibres due to capillary effects can be readily transferred to the coat when the cleaning surface comes into contact with it. The brush-type trimming makes it possible for the transferred moisture to be worked into the coat. Furthermore, the bristles can work foreign bodies out of the coat When groomed with the animal grooming glove, the coat of the animal is polished and is given a fine gloss.

The present invention also concerns an animal coat grooming kit with an animal coat grooming glove in accordance with any one of claims 1 to 16 or claims 17 to 24, as well as a spray bottle to contain a nutrient and/or grooming solution for an animal coat. The nutrient and/or grooming solution preferably contains natural substances for grooming and cleaning the animal coat. Advantageously, the nutrient and/or grooming solution will contain Ayurvedic substances. The substances may be antiseptic and/or smell-retaining. Advantageously, the nutrient and/or grooming solution will be aqueous.

The invention will now be described in greater detail with reference to the figures, of which:

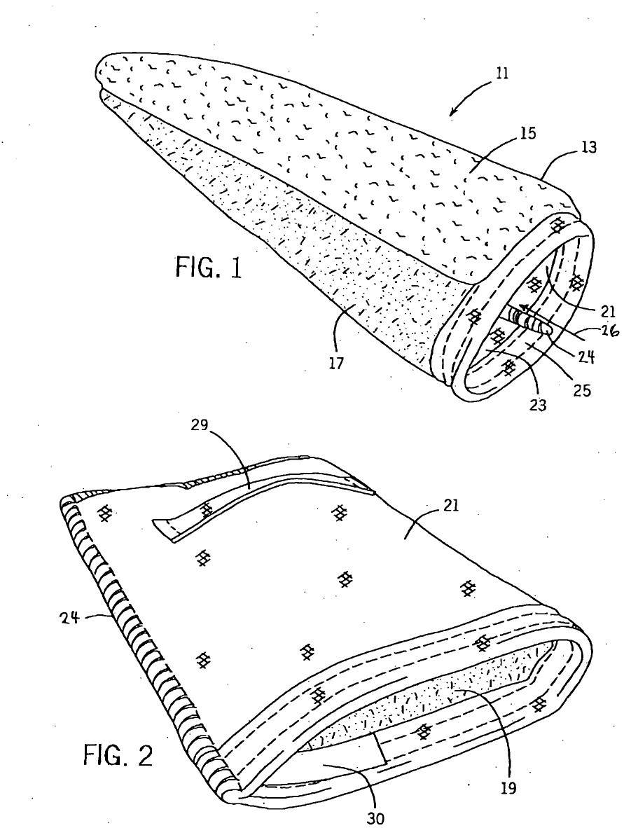

FIG. 1 shows a perspective view of a glove in accordance with the invention;

FIG. 2 shows the glove of FIG. 1 when it is turned inside out;

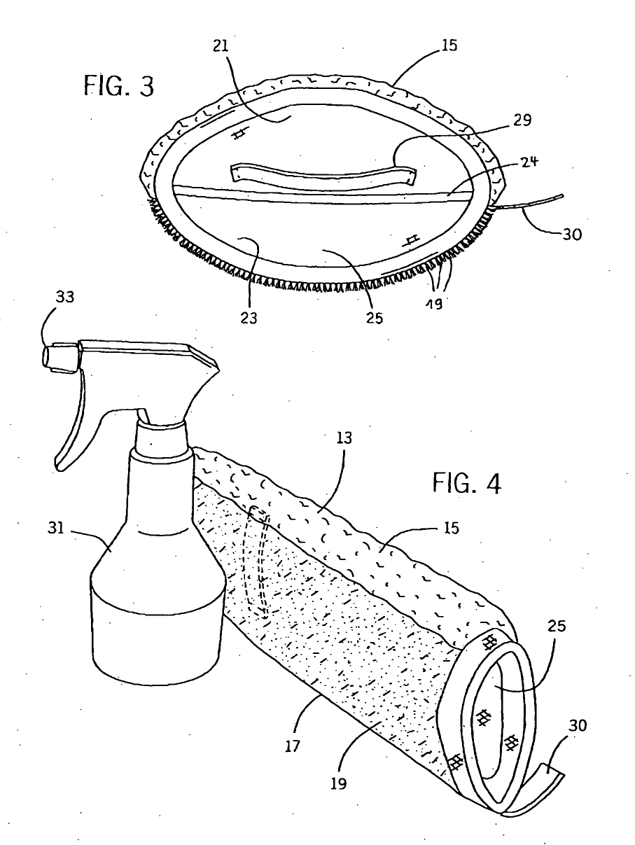

FIG. 3 shows the inside of the bag-like glove as seen from in front;

FIG. 4 shows an animal grooming kit consisting of an animal grooming glove and a spray bottle to contain a grooming and/or cleaning solution.

The glove 11 in accordance with the invention as shown in FIGS. 1 to 3 is provided with a first cleaning surface 13, which has a pile consisting of microfibres 15, and a second cleaning surface 17, which is provided with a brush-type trimming 19. The microfibres 15 and the brush-type trimming 19 are anchored in a known manner in base fabrics (hosiery, knitted or preferably woven fabrics) 21 and/or 23. The base fabrics 21, 23 are rectangular pieces that have their edges sewn together along three sides by means of a seam 24. The grooming glove has an opening 25, through which a hand may be inserted in the insertion direction 26 (arrow) into the glove, which is designed as a mitten.

The first cleaning surface has a covering with microfibres. The microfibres have a fineness count of not more than 50 dtex, preferably not more than 25 dtex and even more preferably not more than 10 dtex. According to a particularly preferred embodiment, the fibres have a fineness count of between 0.1 and 2 dtex. In each case a multiplicity of fibres is combined into a thread and bound into the base fabric. The length of the projecting threads amounts to more than 1 mm, preferably more than 5 mm and even more preferably more than 8 mm. The threads are preferably in the form of slings that in the fully stretched condition have a length of preferably not less than 5 mm and even more preferably between 7 mm and 15 mm. The microfibre covering is sufficiently dense to form a soft and closed surface.

The brush-type covering of the second cleaning surface consists of discreetly anchored bristle tufts. The small bristles of the bristle tufts are preferably made of polypropylene, polyester, polyamine, polycarbonate or similar, though polypropylene is preferred. A bristle cluster consists on average of at least 10, preferably more than 20 and even more preferably between 5 and 50 small bristles. A small bristle is to be understood as the bristle tips that can be distinguished in the bristle cluster. The small bristles are combined into bristle tufts and anchored in the fabric in such a way that the bristles project from the surface in an upright manner, preferably at approximately a right angle. With a view to consolidating the bristles, they may also be impregnated, glued or fused in the base material or fabric. The visco-elastic bristles preferably protect from the base fabric for a length of more than 2 mm and preferably more than 3 mm up to a maximum of 5 mm and at approximately a right angle. A bristle length between 2 mm and 3.5 mm has proved to be particularly advantageous. The bristles and microfibres may be given different colours in order to characterize the different functionalities of the two opposite cleaning surfaces.

According to another aspect of the invention, a loop 29 is provided on the interior side 27 of the glove 11 (FIG. 2). The loop 29 is situated in the forward half of the grooming glove and its width is less than that of the glove 11. Depending on the width of the hand, either the whole hand or individual fingers may be inserted in the loop 29. When the hand or the fingers are inserted in the loop, a slipping of the glove is effectively prevented while the glove is being used, for example, for grooming the coat of an animal. The loop 29 is preferably an elastic band made of textile or plastic material that is capable of changing its length.

The glove can be hung up on a hook by means of a second loop 30 that is sewn to a side of the glove.

The animal coat grooming glove in accordance with the invention is particularly suitable for moist grooming of an animal coat. According to the invention, there is thus proposed an animal coat grooming kit with an animal coat grooming glove and a spray bottle 31. The spray bottle is provided with a nozzle 33 for atomizing the liquid contents of the bottle. The animal coat grooming kit is particularly suitable for the application to the coat of nutrient and grooming solutions. These may also contain additives to prevent the formation of odours, antiseptic substances, etc. Preferably, use will be made of Ayurvedic solutions.

The animal coat grooming glove and/or the animal coat grooming kit are used in the following manner. The desired aqueous grooming solution is filled into the spray bottle. The microfibre surface of the grooming glove is then moistened with the nozzle. Due to capillary effects, the aqueous solution penetrated into the microfibre surface. The moisture is then transferred to the animal coat by moving the microfibre cleaning surface across the animal coat, exerting a slight pressure. This application may be repeated several times until the entire coat has been moistened. The animal coat is then worked with the brush-type covering and edging. The fine bristles of the second cleaning surface distribute the moisture over the entire coat and at the same time remove any foreign bodies. The animal coat is polished by the grooming as here described and assumes a natural lustre.

### EMBODIMENT EXAMPLE

| | |
|---|---|
| Pile weave: | PP (polyethylene) |
| Backing weave: | PES (polyethersulfone) |
| Weight per unit area: | 380 g/m2 |
| Total thickness of the second | 3 mm |
| cleaning surface with upright pile: | |
| Length of the slings: | 10 mm |

The invention described hereinabove relates to a glove and a grooming kit for an animal coat. The glove comprises at least one first cleaning surface consisting of microfibres and a second cleaning surface with a brush-type trimming. The microfibre surface can retain large amounts of moisture by capillary action, said moisture being in turn easily transferred to the coat of an animal that is to be groomed when the coat is groomed with the microfibre side. The brush-type trimming, consisting of individual tufts of bristles, is used to transfer the moisture to the interior of the coat and to simultaneously remove foreign bodies from said coat. The interior of the glove is provided with a loop into which individual fingers or optionally the whole hand may be inserted. The loop permits a good grip and ensures that the hand cannot slip inside the glove.

Legend:

| | |
|---|---|
| 11 | Cleaning and/or grooming glove |
| 13 | First cleaning surface |
| 15 | Microfibres |
| 17 | Second cleaning surface |
| 19 | Brush-type trimming and edging |
| 21 | Base fabric of the micro fibre surface |
| 23 | Base fabric of the brush-type trimming |
| 24 | Seam |
| 25 | Opening of the glove |
| 26 | Insertion direction |
| 27 | Interior side |
| 29 | Loop |
| 30 | Second loop for hanging up the glove |
| 31 | Spray bottle |
| 33 | Nozzle |

1. A cleaning glove with two different cleaning surfaces, a first cleaning surface that is covered with microfibres and a second cleaning surface that is different from the first cleaning surface and has a brush-type trimming made of a multiplicity of bristle tufts arranged at some distance from each other, characterized in that
the fibres of the first cleaning surface are microfibres and the bristle tufts are from band yarn of multifil yarn, the band yarn or multifil yarn being fanned out or split up into a multiplicity of individual small bristles.

2. A glove in accordance with claim 1, characterized in that the first cleaning surface of the glove has a pile made of microfibres.

3. A glove in accordance with claim 2, characterized in that the microfibres have a fineness count of not more than 5 dtex, preferably not more than 2 dtex and even more preferably a fineness count of not more than 1 dtex.

4. A glove in accordance with claim 1, characterized in that the first cleaning surface is covered with (pile) threads or slings (loops) formed from microfibres.

5. A glove in accordance with claim 1, characterized in that the microfibres in the stretched condition have a length between 7 and 15 mm.

6. A glove in accordance with claim 1, characterized in that the brush-type trimming has bristles made of polyester, polyamide or polypropylene.

7. A glove in accordance with claim 6, characterized in that the brush-type trimming consists of a multiplicity of bristle tufts arranged at some distance from each other.

8. A glove in accordance with claim 1, characterized in that the bristle tuftstrimmings are obtained from band yarn or multifil yarn.

9. A glove in accordance with claim 7, characterized in that the bristle tufts consist on average of at least 10, preferably of more than 20 and even more preferably of between 5 and 50 small bristles.

10. A glove in accordance with claim 1, characterized in that on at least one interior side of the glove there is provided a loop into which a hand or several individual fingers may be inserted.

11. A glove in accordance with claim 10, characterized in that the loop is made of a textile band or a plastic band.

12. A glove in accordance with claim 10, characterized in that the loop consists of a yielding or elastic band.

13. A glove in accordance with claim 10, characterized in that the loop is less wide than the opening for the insertion of the hand.

14. A glove in accordance with claim 10, characterized in that the loop is arranged in the forward half of the glove and at some distance from the tip of the glove.

15. A glove in accordance with claim 1, characterized in that the glove consists of two layers that are joined to each other on three sides of their circumference.

16. A glove in accordance with claim 1, characterized in that at least one loop is arranged on each of the interior sides of the glove.

17. A cleaning and grooming glove with
at least a first cleaning surface provided with cleaning fibres, cleaning threads or the like, characterized in that
the glove is bag-like with an opening for the insertion of a hand in an insertion direction and that on at least one interior side of the glove there is arranged at least one loop into which a hand or several individual fingers may be inserted.

18. A glove in accordance with claim 17, characterized in that the loop consists of a textile band or a plastic band.

19. A glove in accordance with claim 17, characterized in that the loop consists of a non-yielding band.

20. A glove in accordance with claim 17, characterized in that the loop is less wide than the opening for the insertion of the hand.

21. A glove in accordance with claim 16, characterized in that the loop is arranged in the forward half of the glove and at some distance from the tip of the glove.

22. A glove in accordance with claim 17, characterized in that the glove consists of two layers that are joined to each other on three sides of the circumference.

23. A glove in accordance with claim 17, characterized in that on each of the interior sides of the glove there is arranged at least one loop.

24. (canceled)

25. A glove in accordance with claim 1 for use as an animal grooming glove.

26. A glove in accordance with claim 1 for use as a cleaning and grooming glove for smooth surfaces, especially for cleaning lacquered surfaces.

27. An animal grooming kit with a glove in accordance with claim 1, as well as a spray bottle to contain a nutrient and/or grooming solution for the coat of an animal.

28. An animal grooming kit with a glove in accordance with claim 1, as well as a spray bottle and a nutrient and/or grooming solution for the coat of an animal.

29. An animal grooming kit in accordance with claims 28, characterized in that the nutrient and/or grooming solution is aqueous.
